(19) United States
(12) Patent Application Publication
(10) Pub. No.: US 2026/0311664 A1
(43) Pub. Date: Oct. 8, 2026

(54) PERCUSSION INSTRUMENT DAMPENING SYSTEM

(71) Applicant: Jordan S. Vachal, Fort Wayne, IN (US)

(72) Inventor: Jordan S. Vachal, Fort Wayne, IN (US)

(21) Appl. No.: 19/641,456

(22) Filed: Apr. 7, 2026

Related U.S. Application Data
(60) Provisional application No. 63/784,909, filed on Apr. 7, 2025.

(51) Int. Cl. G10D 13/14

(52) U.S. Cl. CPC G10D 13/14

(57) ABSTRACT

A dampening system that is engageable with a percussion instrument, such as a drum, is described. The dampening system includes a dampening member having a surface adapted to selectively contact a striking surface of the percussion instrument to reduce vibration of the striking surface, a dampening member positioning mechanism adapted to move the dampening member between a dampening position and an undampening position; a strike detecting system adapted to detect a strike of the striking surface, and a controller adapted to receive a signal from the strike detecting system and to control the dampening member positioning mechanism in response to the signal. When a strike is detected by the strike detecting system, the controller causes the dampening member positioning mechanism to move the dampening member from the dampening position to the undampening position.

### PRIORITY

The present application claims the benefit of domestic priority based on U.S. Provisional Patent Application 63/784,909 filed on Apr. 7, 2025, the entirety of which is incorporated herein by reference.

### BACKGROUND

Percussion instruments are musical instruments that are struck by a hand or striking member to produce sound. Examples of percussion instruments include membranophones, such as drums, timpani, and some tambourines, which produce sound when a membrane is struck with a hand, mallet, stick, beater, or the like, and idiophones, such as cymbals and triangles, which produce sound through vibration of their entire body.

One problem with percussion instruments, particularly membranophones, is that the instrument can sometimes produce unwanted sounds. For example, a membrane can continue to resonate naturally for longer than desired after a strike. In this case, the resulting sound may need to be manipulated in a way to create a more useful or pleasing sound or may need to be silenced. Sometimes, a membrane can be caused to vibrate by nearby vibrations, such as vibrations from another musical instrument, a loudspeaker, and/or ambient noise. These unwanted sounds will often need to be modified or suppressed in order to avoid compromising the overall sound.

Conventionally, these unwanted vibrations have been dealt with in crude manners. For example, musicians will sometimes use tape, foam, adhesive gel, and/or other mass to help reduce the effects. However, these techniques are not ideal. These passive and non-reactive techniques can compromise the tone and timbre of the instrument upon strike, are not easily adjustable or modifiable, and are often not effective in suppressing resonation between strikes if not properly and/or sufficiently applied.

Products that have been introduced to try to combat the problem have also proven to be less than ideal. For example, active dampening systems have been developed that control the sustain time on a drum by a use of a plunger type mechanism on a drumhead. Weighted drum dampeners made from felt, ball bearings, and silicone have been developed that sit on and bounce freely on a drum head to dampen vibration. However, these systems suffer from several disadvantages. For example, these systems are not controllable beyond their static physical properties, they often do not provide enough dampening to effectively and sufficiently suppress the resonances between strikes, they cannot be easily adjusted, they alter the playability of the instrument, and/or they change the way a stick or other striking object rebounds.

Therefore, there is a need for an improved dampening system for use with and/or that is part of a percussion instrument. There is a further need for an improved percussion instrument dampening system that reduces unwanted sound while lessening the effect on wanted sound. There is a further need for a dampening system that overcomes one or more of the disadvantages associated with convention systems or techniques.

### SUMMARY

The present invention satisfies one or more of these needs. In one aspect of the invention, an improved percussion instrument dampening system is provided.

In one aspect of the invention, a percussion instrument dampening system is provided that reduces unwanted sound while lessening the effect on wanted sound.

In another aspect of the invention, a percussion instrument dampening system includes a dampening member that is moveable between a first or dampening position and a second or undampening position.

In another aspect of the invention, a percussion instrument dampening system includes a dampening member that is moveable between a first or contacting position where the dampening member places the percussion instrument in a dampened condition and a second or non-contacting position where the dampening member places the percussion instrument in an undampened condition.

In another aspect of the invention, a percussion instrument dampening system includes a dampening member that is moveable in response to a detected condition.

In another aspect of the invention, a percussion instrument dampening system includes a dampening member that is automatically moveable in response to a detected condition.

In another aspect of the invention, a percussion instrument dampening system includes a dampening member that moveable in response to a detected condition, wherein the detected condition is a strike that has or that will soon happen, such as by being in the process of happening.

In another aspect of the invention, a percussion instrument dampening system comprises a dampening member that automatically moves between a first or dampening position in which the dampening member dampens a percussion instrument and a second or undampening position in which the percussion instrument is undampened.

In another aspect of the invention, a percussion instrument dampening system comprises a dampening member that automatically moves between a first or dampening position in which the dampening member dampens a percussion instrument and a second or undampening position in which the percussion instrument is undampened and that automatically moves back to the first position after a period of time has lapsed.

In another aspect of the invention, a percussion instrument dampening system comprises a dampening member that is moveable between a first or dampening position in which the dampening member dampens a percussion instrument and a second or undampening position in which the percussion instrument is undampened, wherein the dampening member is moved from the first position to the second position in response to a detected condition.

In another aspect of the invention, a percussion instrument dampening system comprises a dampening member that is moveable between a first or dampening position in which the dampening member dampens a percussion instrument and a second or undampening position in which the percussion instrument is undampened, wherein the dampening member is moved from the first position to the second position in response to a detected condition, wherein the detected condition is a striking of the percussion instrument.

In another aspect of the invention, a percussion instrument dampening system comprises a dampening member that is moveable between a first or dampening position in which the dampening member dampens a percussion instrument and a second or undampening position in which the percussion instrument is undampened, wherein the dampening member is moved from the first position to the second position in response to a detected condition, wherein the detected condition is a striking of the percussion instrument, and wherein the detected condition is contact with a striking surface of the percussion instrument.

In another aspect of the invention, a percussion instrument dampening system comprises a dampening member that is moveable between a first or dampening position in which the dampening member dampens a percussion instrument and a second or undampening position in which the percussion instrument is undampened, wherein the dampening member is moved from the first position to the second position in response to a detected condition, wherein the detected condition is a striking of the percussion instrument, and wherein the detected condition is the movement of an object towards a striking surface of the percussion instrument.

In another aspect of the invention, a percussion instrument dampening system comprises a dampening member that is moveable between a first or dampening position in which the dampening member dampens a percussion instrument and a second or undampening position in which the percussion instrument is undampened, wherein the dampening member is moved from the first position to the second position in response to a detected condition, wherein the detected condition is a striking of the percussion instrument, wherein the detected condition is the movement of an object towards a striking surface of the percussion instrument, and wherein the striking object is a hand or a drumstick.

In another aspect of the invention, a percussion instrument dampening system comprises a dampening member that dampens the percussion instrument until a trigger event causes the dampening member to move to reduce or remove the dampening of the percussion instrument.

In another aspect of the invention, a percussion instrument dampening system comprises a dampening member that dampens the percussion instrument until a trigger event causes the dampening member to move to reduce or remove the dampening of the percussion instrument, wherein the trigger event is a strike of a striking surface of the percussion instrument.

In another aspect of the invention, a percussion instrument dampening system comprises a dampening member that dampens the percussion instrument until a trigger event causes the dampening member to move to reduce or remove the dampening of the percussion instrument, wherein the trigger event is an object making contact with a striking surface of the percussion instrument.

In another aspect of the invention, a percussion instrument dampening system comprises a dampening member that dampens the percussion instrument until a trigger event causes the dampening member to move to reduce or remove the dampening of the percussion instrument, wherein the trigger event is an object moving towards a striking surface of the percussion instrument.

In another aspect of the invention, a percussion instrument dampening system comprises a plurality of dampening members that are moveable between a first or dampening position in which the dampening member dampens a percussion instrument and a second or undampening position in which the percussion instrument is undampened, wherein the plurality of dampening members are moved from the first position to the second position in response to a detected condition.

In another aspect of the invention, a percussion instrument comprises a plurality of striking surfaces and a percussion instrument dampening system comprises a dampening member associated with each striking surface, each dampening member being moveable between a first or dampening position in which the dampening member dampens a percussion instrument striking surface and a second or undampening position in which the percussion instrument striking surface is undampened, wherein the dampening member is moved from the first position to the second position in response to a detected condition.

In another aspect of the invention, a percussion instrument comprises a plurality of striking surfaces and a percussion instrument dampening system comprises a dampening member associated with each striking surface, each dampening member being moveable between a first or dampening position in which the dampening member dampens a percussion instrument striking surface and a second or undampening position in which the percussion instrument striking surface is undampened, wherein the dampening member is moved from the first position to the second position in response to a detected condition, wherein the detected condition is a strike of a respective striking surface.

In another aspect of the invention, a method of dampening a percussion instrument comprises providing a dampening system as described herein and using the dampening system as described herein.

In another aspect of the invention, a percussion instrument dampening system comprises a percussion instrument having a striking surface that can be struck to generate a sound; and a dampening system engageable with the percussion instrument, wherein the dampening system comprises: a dampening member having a surface adapted to selectively contact the striking surface of the percussion instrument to reduce vibration of the striking surface; a dampening member positioning mechanism adapted to move the dampening member between a dampening position and an undampening position; a strike detecting system adapted to detect a strike of the striking surface; and a controller adapted to receive a signal from the strike detecting system and to control the dampening member positioning mechanism in response to the signal, wherein when a strike is detected by the strike detecting system, the controller causes the dampening member positioning mechanism to move the dampening member from the dampening position to the undampening position.

In another aspect of the invention, a percussion instrument dampening system comprises a percussion instrument having a striking surface that can be struck to generate a sound; and a dampening system engageable with the percussion instrument, wherein the dampening system comprises: a dampening member having a surface adapted to selectively contact the striking surface of the percussion instrument to reduce vibration of the striking surface; a dampening member positioning mechanism adapted to move the dampening member between a dampening position and an undampening position; a strike detecting system adapted to detect a strike of the striking surface; and a controller adapted to receive a signal from the strike detecting system and to control the dampening member positioning mechanism in response to the signal, wherein when a strike is detected by the strike detecting system, the controller causes the dampening member positioning mechanism to move the dampening member from the dampening position to the undampening position, wherein the controller causes the dampening member positioning mechanism to move from the undampening position to the dampening position when a period of time after the strike has lapsed.

In another aspect of the invention, a percussion instrument dampening system for use with a percussion instrument comprises a dampening member having a surface adapted to selectively contact the striking surface of the percussion instrument to reduce vibration of the striking surface; a dampening member positioning mechanism adapted to move the dampening member between a dampening position and an undampening position; a strike detecting system adapted to detect a strike of the striking surface; and a controller adapted to receive a signal from the strike detecting system and to control the dampening member positioning mechanism in response to the signal, wherein when a strike is detected by the strike detecting system, the controller causes the dampening member positioning mechanism to move the dampening member from the dampening position to the undampening position.

In another aspect of the invention, a method of dampening a percussion instrument comprises providing a percussion instrument having a striking surface that can be struck to generate a sound; providing a dampening member in a dampening position where the dampening member contacts the striking surface to reduce vibration of the striking surface; detecting a strike of the striking surface; and in response to the detected strike, moving the dampening member to an undampening position.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic, partially sectional side view of a version of a percussion instrument dampening system of the invention in a dampened condition;

FIG. 1B is a schematic, partially sectional side view of the percussion instrument dampening system of FIG. 1A in an undampened condition;

FIG. 2 is a schematic perspective view of another version of a percussion instrument dampening system of the invention;

FIG. 3 is a schematic sectional side view of the percussion instrument dampening system of FIG. 2;

FIG. 4 is a schematic side view of a portion of a version of a percussion instrument dampening system of the invention;

FIG. 5 is a schematic sectional side view of another version of a percussion instrument dampening system of the invention;

FIG. 6 is a schematic perspective view of another version of a percussion instrument dampening system of the invention;

FIG. 7 is a control schematic for a version of a percussion instrument dampening system having multiple dampening members; and

FIG. 8 is a control schematic for a version of a percussion instrument dampening system having multiple striking surfaces.

### DESCRIPTION

The present invention relates to a musical instrument and/or a musical instrument accessory. In particular, the invention relates to a dampening system that is useable with or as an integral part of a percussion instrument. Although the invention is illustrated and described in the context of being useful for dampening a percussion instrument, such as a drum, the present invention can be used in other ways, as would be readily apparent to those of ordinary skill in the art. Accordingly, the present invention should not be limited just to the examples and embodiments described herein.

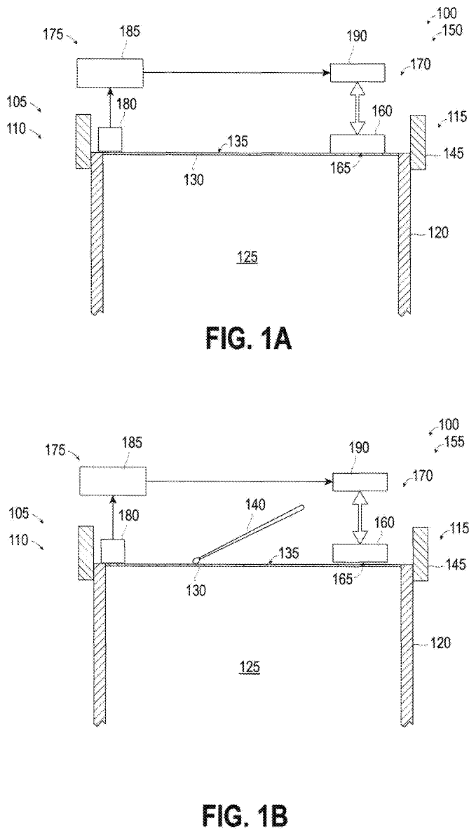

FIGS. 1A and 1B show a version of a percussion instrument dampening system 100 according to one version of the invention. The percussion instrument dampening system 100 can be an accessory that is usable with a percussion instrument or can be integrated into and include the percussion instrument itself. As shown in FIG. 1A, the percussion instrument dampening system 100 is associated with a percussion instrument 105 and is used to improve the usefulness and/or sound generated by the percussion instrument 105. In the version of FIG. 1A, the percussion instrument dampening system 100 is illustrated and described in association with a percussion instrument 105 in the form of a drum 110. The drum 110 comprises a drum body 115 having a cylindrical or otherwise shaped drum shell 120 that defines a hollow drum interior 125 covered by a membrane 130, more commonly referred to as a drumhead or skin, that has a striking surface 135 upon which an object can strike the striking surface to generate sound. As will be understood, the drum 110 is played by a user striking the striking surface 135 of the membrane 130 to generate a sound, particularly a musical sound. When struck, the membrane 130 vibrates, creating sound waves by compressing air molecules in and around the shell 120. The type and shape of the shell 120 can amplify and/or shape the tone of the sound generated. The striking object that strikes the striking surface 135 can be, for example, a user's hand or fingers or a striking member 140 as shown in FIG. 1B. Examples of striking members 140 include beaters, sticks, drumsticks, mallets, rutes, brushes, and the like. The drum body 115 also includes a rim 145, or hoop, that holds the membrane 130 onto the shell 120. The drum 110 can be in the form of any type of drum, such as a snare drum, bass drum, tom-tom, hand drum, bongo, conga, djembe, marching drum, concert drum, timpani, and the like. Often, the drum 110 will be part of a drum kit or set that comprises multiple types or versions of drums. While illustrated in FIGS. 1A and 1B and throughout in association with a drum 110, the percussion dampening system 100 of the invention can be used with any percussion instrument, including other membranophones, such as drums, timpani, and membrane-containing tambourines, in which the striking surface 135 is on a vibrating membrane 130, and idiophones, such as cymbals and triangles, which produce sound through vibration of their entire body and in which the striking surface 135 is an exterior surface of the body. It is to be understood that the percussion dampening system 100 described herein can be adapted to any of these or other types of percussion instruments.

The percussion instrument dampening system 100 in the version as shown in FIGS. 1A and 1B serves to improve, alter, and/or augment the sound generated by the drum 110 when it is being played. For example, the percussion instrument dampening system 100 can improve, alter, and/or augment the sound of a percussion instrument when it is struck and/or for a period of time following a strike. The percussion instrument dampening system 100 provides for selective and/or customized dampening of the drum 110 in a manner that helps to prevent unwanted vibrations and/or artifacts while maintaining a desired sound or tone that is undampened and purer. The percussion instrument dampening system 100 operates to apply a dampening effect at times when the drum is not being played and to remove or lessen the dampening effect at times when the drum is being played and the sound being generated is desired.

FIG. 1A shows the percussion instrument dampening system 100 in a dampened condition 150, and FIG. 1B shows the percussion instrument dampening system 100 in an undampened 155 or playing condition. The percussion dampening system 100 includes a dampening member 160 that has a contact surface 165 positioned, designed, and/or adapted to selectively contact the striking surface 135 in a manner that is capable of dampening the vibration of the striking surface 135. By dampening it is meant that the magnitude or amplitude of the vibration of the surface is reduced or less than it would be in the absence of the dampening. In the dampened condition 150 shown in FIG. 1A, the contact surface 165 is shown in a first or dampening position in which it causes a dampening effect on the percussion instrument 105. For example, the first or dampening position can be a contacting position where the dampening member 160 contacts the striking surface 135. In the undampened condition 155 shown in FIG. 1B, the contact surface 165 is shown in a second or undampening position in which it causes no or reduced dampening effect on the percussion instrument 105. For example, the second or undampening position can be a non-contacting position where the dampening member 160 is spaced from the striking surface 135.

A dampening member positioning mechanism 170 is engageable with the dampening member 160 to move the dampening member 160. For example, the dampening member positioning mechanism 170 can move the dampening member between its first position, as shown in FIG. 1A, and its second position, as shown in FIG. 1B. The movement of the dampening member 160 to the first position produces a dampened condition 150, and the movement of the dampening member 160 to the second position produces an undampened condition 155. By dampened condition it is meant that the magnitude or amplitude of the vibration of the striking surface or other portion of the percussion instrument is reduced or less than it would be in the absence of being in the dampening condition. By undampened condition, it is meant that the dampening effect is reduced relative to the dampened condition. By dampening position, it is meant that the dampening member is in a position that creates or causes a dampened condition, and by undampening position, it is meant that the dampening member is in a position that creates or causes an undampened condition. The movement of the dampening member can be performed manually and/or automatically, as discussed below.

In one version, such as shown in FIG. 1A, the dampening position of the dampening member 160 is a contacting position in which the contact surface 165 of the dampening member 160 physically contacts the striking surface 135, and the undampening position is a non-contacting position in which the contact surface 165 of the dampening member 160 is spaced from the striking surface 135. The contact surface 165 can be any material and/or shape that provides a desired dampening effect. For example, in a particular version, the contact surface 160 comprises a soft material, such as a spongelike material and/or felt which can help to reduce chatter and/or artifacts.

In the version shown in FIGS. 1A and 1B, the percussion instrument dampening system 100 is designed to automatically adjust the dampening effect, such as by moving the dampening member 160 between the dampening position of FIG. 1A and the undampening position of FIG. 1B, in response to a sensed or detected condition. For example, the percussion instrument dampening system 100 can move the dampening member 160 so that the percussion instrument dampening system 100 is in a dampened condition 150 when it is desired that unwanted vibration or other sounds be suppressed and can move the dampening member 160 so that the percussion instrument dampening system 100 is in its undampened condition 155 when it is desired that the sound generated by the drum 110 be more pure and unsuppressed. As shown, a control system 175 can be provided for controlling the movement and/or position of the dampening member 160 in response to a detected condition.

In the particular version of FIGS. 1A and 1B, the control system 175 is designed to detect when a strike is happening or is soon to happen and to adjust the positioning of the dampening member 160 in response to the detection. In this version, the control system 175 comprises a strike detecting system 180 capable of detecting when a strike is made, is being made, or is soon to be made. When a strike is detected, a signal is generated and sent to a controller 185. In response to the detection and/or the signal, the controller 185 sends a signal to a dampening member actuator 190, such as an electromechanical actuator that is operably connected to or engageable with the dampening member 160, to cause the dampening member actuator 190 to move the dampening member 160 from the dampening position of FIG. 1A in which the percussion instrument is in a dampened condition 150 to the undampening position of FIG. 1B in which the percussion instrument is in an undampened condition 155. In this manner, when the drum 110 or other percussion instrument 105, is detected as being or soon to be struck by a user, the drum 110 can be in its natural, undampened condition and a pure sound can be generated from the strike and/or a less dampened sound can be generated relative to the dampened condition. Accordingly, the detection of a strike can serve as a trigger for the percussion instrument dampening system 100 that causes the controller 185 to move the dampening member 160 or otherwise adjust the dampening effects of the percussion instrument 105.

After a period of time has elapsed following the detection of a strike, the controller 185 and/or the actuator 190 can cause the dampening member 160 to return to its dampening position of FIG. 1A so the percussion instrument 105 can be returned to its dampened condition 150. In this position, the drum 110, or other percussion instrument 105, will generate less unwanted sound between strikes than would occur in an undampened configuration 155. More specifically, the effects of vibrations from the nearby environment, such as those picked up from other instruments or other vibrations that might otherwise generate a resonance response in the drum 100, will be suppressed by the percussion instrument dampening system 100. The percussion dampening system 100 then remains in the damped condition 150 until the next strike is detected by the strike detecting system 180. The period of time can be at least about 50 msec. The period of time can be preselected or can be adjustable by a user. In one version, the period of time can be preset and/or can be selectable to be a period of time of from about 50 msec to about 5 seconds, or from about 100 msec to about 2 seconds. The preselected or selected period of time will depend on the system being used, the percussion instrument, and the subjective preferences of the user.

When the strike is detected, the movement of the dampening member 160 to an undampening position will be as quick as reasonably possible, and will be nearly instantaneous. After the period of time has lapsed and the dampening member 160 is to be returned to its dampening position, the movement can be as quick as possible or can be slower than the movement from the dampening position to the undampening position. For example, in some situations, it may be desired to more slowly move the dampening member to its dampening position. The speed at which the dampening member is moved will influence the sustain and decay curve of the instrument. A relatively fast movement of the dampening member 160 to the dampening position will cause a note to be more quickly dampened. A slower movement with more gradual force application will create a longer decay curve. The speed of movement of the dampening member 160 can be predetermined or can be selectable or adjustable by a user. For example, a user may have a personal taste and/or want to select a faster movement time for a fast paced tempo than for a slower paced tempo.

The percussion instrument dampening system 100 thus provides an adjustable, dynamic, and/or reactive percussion instrument dampening system. The percussion instrument dampening system can be used to modify the resonation characteristics of an instrument after it has been struck. The percussion instrument dampening system 100 can also be used to suppress the resonation in a drum while not actively being struck.

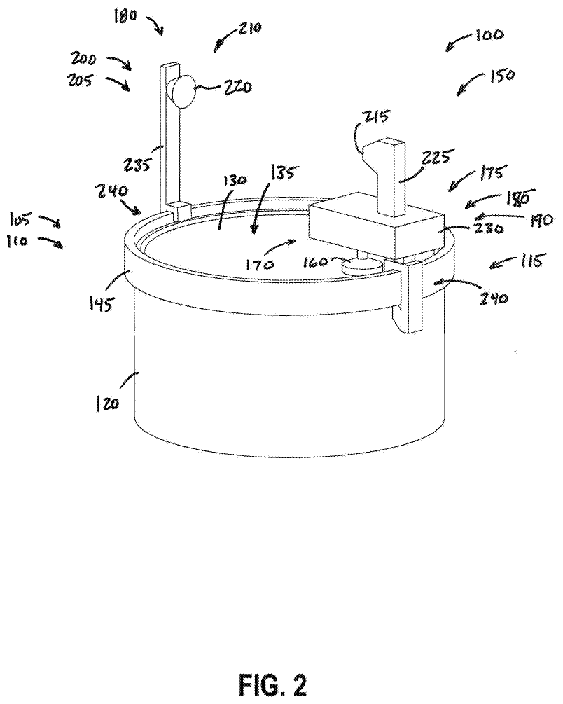

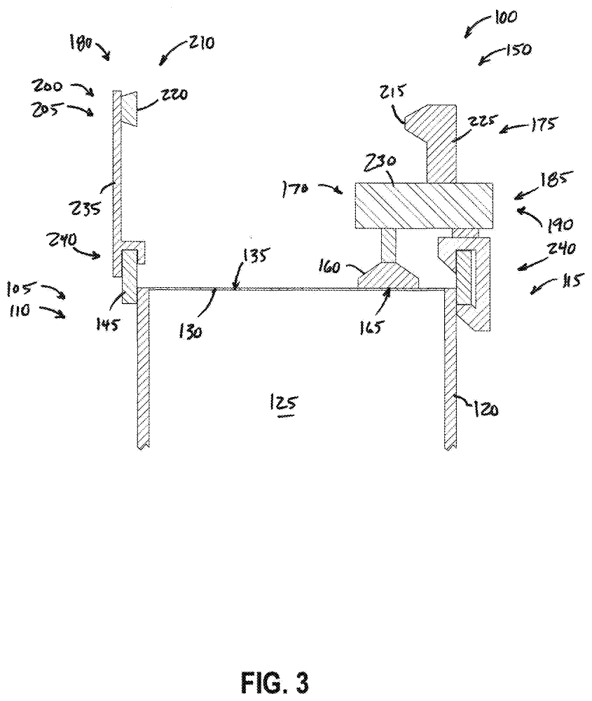

FIG. 2 shows a perspective view and FIG. 3 shows a side view of a version of a percussion instrument dampening system 100 of the invention in which the strike detecting system 180 comprises a movement sensing system 200 that includes a movement sensor 205 that can detect the movement of an object, such as a hand or other striking member, towards the striking surface 135. For example, the percussion instrument dampening system 100 can comprise a movement sensor 205 that will detect when a musician is intending and/or in the process of striking the percussion instrument 105. In the version shown, the movement sensor 205 of the strike detecting system 180 comprises a break-beam style sensor 210. When an object, such as a hand or other striking object 140, such as a drumstick, passes through the break-beam style sensor 210 beam before it hits the striking surface 135, the breaking of the beam triggers to the controller 185 that the striking surface 135 is soon to be hit so that the controller 185 can cause the percussion instrument dampening system 100 to move to an undampened condition 155 which will occur as, just before, or just after the striking surface 135 is struck. In the particular version of FIG. 2, the break-beam style sensor 210 comprises a sensor transmitter 215 that projects a beam across the striking surface 135, and an opposing sensor receiver 220 receives the beam. When an object, such as a hand or striking member 140 breaks the beam, the receiver 220 detects the break and provides a signal to the controller 185 by a wire or wireless connection. In the version shown, the transmitter 215 is position on a post 225 that extends from a housing 230 that houses the controller 185 dampening member positioning system 170, and the receiver 220 is mounted on a post 235 mountable on the opposite side of the drum body 115 than the housing 230. Clamping members 240 can be provided to releasably connect the housing 230 and transmitter post 225 and/or the receiver post 235 to the drum rim 145 or other part of the drum 110 or other percussion instrument 105. Alternatively, the parts can be permanently connected. In another version, the positioning of the transmitter 215 and the receiver 220 can be switched and/or the receiver 220 can be a reflector.

As in the version of FIGS. 1A and 1B, in the version of FIGS. 2 and 3, the dampening member 160 contacts, rests on, or otherwise engages the striking surface 135 of the percussion instrument 105 to place the system in the dampened condition 150 in its default state. When a strike is detected by the strike detection system 180, a controller 185 or processor will cause the dampening member positioning mechanism 170 to move the dampening member 160 so that is it mechanically decoupled from the striking surface 135 to allow the percussion instrument 105 to vibrate and/or resonate freely for a predetermined or adjustable period of time at which time the dampening member 160 will be returned to the default state so that unwanted sounds can be dampened.

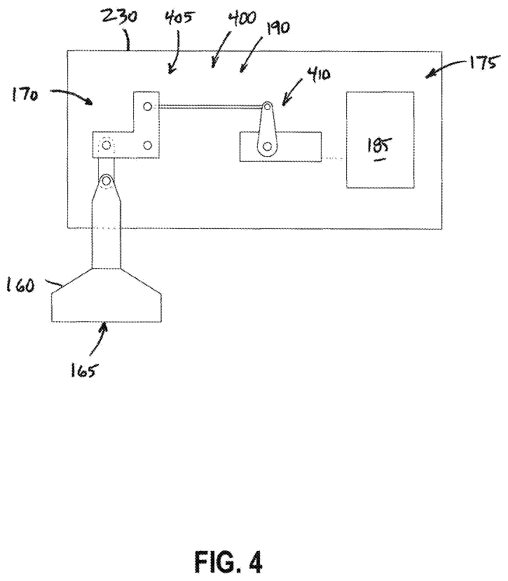

FIG. 4 shows the interior of a version of the housing 230 of the version of FIGS. 2 and 3. In this version, the dampening member positioning mechanism 170 can include an electromechanical motor and actuator system 400. The electromechanical motor and actuator system 400 comprises a mechanical linkage 405 that converts rotational motion from a motor 410 to translational movement of the dampening member 160. In this version, the controller 185 controls operation of the motor 410 and thereby controls the positioning of the dampening member 160. Alternatively, the movement can be achieved by any other type of system, such as an electromagnetic system.

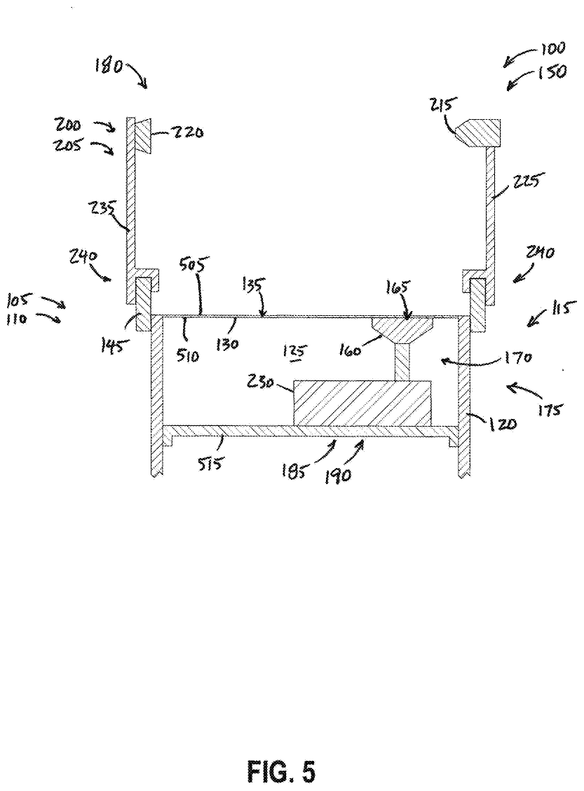

FIG. 5 shows another version of a percussion instrument dampening system 100 of the invention. The version of FIG. 5 is similar to the version of FIGS. 2 and 3. However, where the dampening member 160 of FIGS. 2 and 3 is configured to contact an upper surface 505 of the striking surface 135, which is the same surface that receives a strike, in the version of FIG. 5 the dampening member 160 has a contact surface 165 that is configured to contact the bottom surface 510 or an interior surface of the striking surface 135, which is a surface opposite the side of the surface that receives a strike. As can also be seen in this version, a supporting member 515 can be provided within the hollow interior 125 for supporting the housing 230, dampening member 160, and/or dampening member positioning mechanism 170.

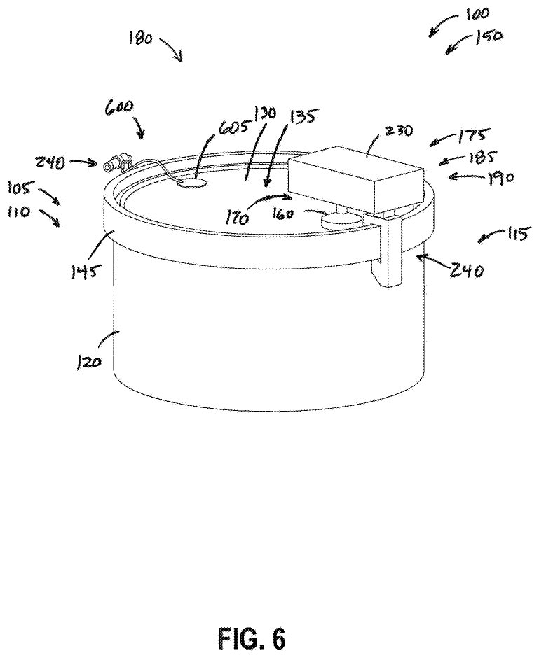

FIG. 6 shows another version of a percussion instrument dampening system 100 of the invention. The version of FIG. 6 is similar to the version of FIGS. 2 and 3. However, in the version of FIG. 6, the strike detecting system 180 comprises a contact sensor 600. The contact sensor 600 has a contact sensor head 605 that contacts the striking surface 135 and uses, for example, a piezoelectric element to detect drumhead vibrations and convert them into an electric signal. Once contact is detected, the electric signal is delivered to the controller 185 and the dampening member 160 is immediately moved to its undampening position.

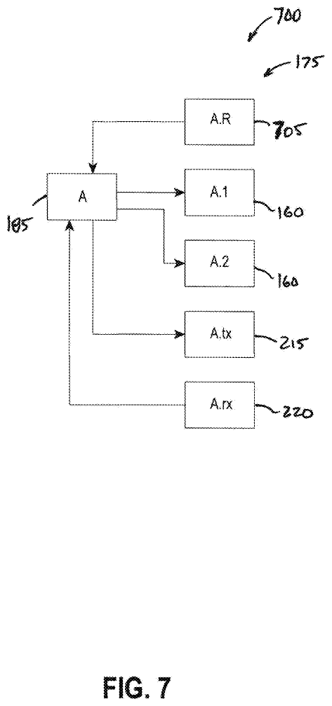

The percussion instrument dampening system 100 can include multiple dampening members 160 and/or multiple strike detecting systems 180. For example, as shown in FIG. 7, a control schematic 700 that illustrates a control system 175 for a percussion instrument dampening system 100 that includes a controller 185 that communicates and/or controls two dampening members 160. Also shown in FIG. 7 is an input device 705, such as a remote control or other user interface, that can be used by a user to enter variables for use by the controller 185, such as the period of time before reapplication of the dampened condition 150 and/or the speed of reapplication of dampening.

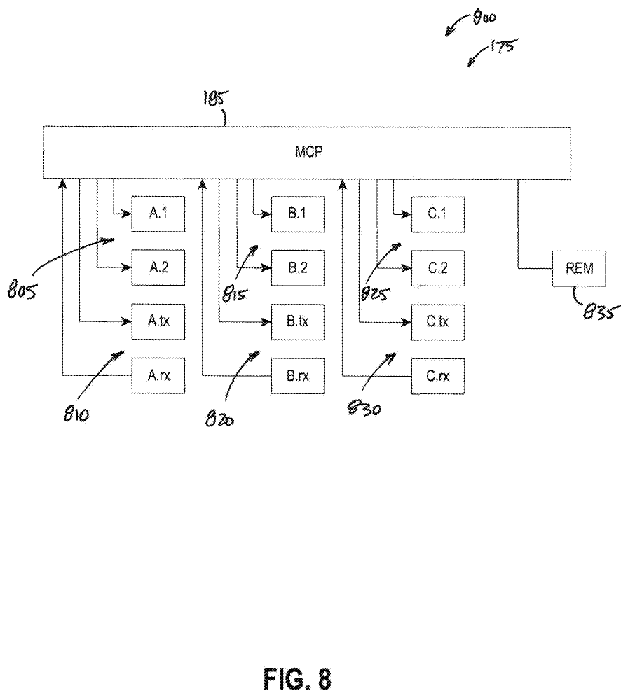

The percussion instrument dampening system 100 can be used to dampen a plurality of percussion instruments 105 and/or a percussion instrument with a plurality of striking surfaces 135. For example, the percussion instrument 105 may be a drum kit or drum set that includes multiple drums 110. In one version, the percussion instrument dampening system 100 thus comprises a plurality of striking surfaces 135 and a corresponding plurality of dampening members 160 and strike detecting systems 180, each associated with a different striking surface 135. In this version, the controller 185 can control each dampening member 160 separated based on the detection of a strike on the respective striking surface. FIG. 8 shows a control schematic 800 that illustrates a control system 175 for a percussion instrument dampening system 100 that includes multiple striking surfaces 135. A controller 185 is a multichannel processor that communicates and/or controls one or more first dampening members 805 and a first strike detecting system 810, one or more second dampening member 815 and a second strike detecting system 820, and one or more third dampening members 825 and a third strike detecting system 830. The multichannel processor remote 835, or other interface, can set values for each of the striking surfaces or one setting can be applied to each. In another version, a single strike detector can be used as the trigger or to otherwise control multiple dampening members 160, including dampening members on different strike surfaces 135.

The controller 185 of the control system 175 can be any device capable of receiving input, performing calculations or executing code, performing calculations or executing code based on the input, producing an output signal, and/or producing an output signal as a result of the calculations or executed code. The controller 185 may be a single controller or multiple controllers that are capable of communication with one another within a single device or across multiple devices. The controller 185 may be in the form of a central processor that is capable of interacting with an operator via an input device, such as a keyboard, a graphical user interface, wireless communication, voice command, or any other manner. For example, the controller 185 may be embodied within personal computer, a laptop, a handheld device, a tablet, a server, a network of servers, a cloud network, or the like. One or more operators may interact with the controller 185 before, during, or after a percussion instrument dampening process. The controller 185 can include various modules that allow it to perform calculations, algorithms, routines, and/or subroutines to process information and/or make determinations. The controller 185 may further include other optional modules, such as storage modules, post-processing modules, artificial intelligence and/or machine learning modules that use algorithms to parse data, learn from the data, and then to make determinations and/or predictions based on what was learned.

Various variations and/or modifications can be included with the percussion instrument dampening system 100. For example, the percussion instrument 100 mounted to the drum rim, shell, or other portion of the drum 110 or other percussion instrument 105. It can also be installed to engage a snare drum's snare wires. The motor/actuator can utilize a positional feedback circuit, much like those found in a servomechanism. The dampening member can be mounted on a separate support stand, for example microphone stand or a cymbal stand. The controller can alternatively be located in a remote housing. The interface for the controller can use any of various communication protocols, such as wifi, Bluetooth, PWM, MIDI, and the like. In one version, a sound engineer mixing a live music show can control the device from the sound booth. Alternative type of sensors that is used to detect the strike can be laser, ultrasound, radar, sonar, lidar, picture motion analysis, and the like. In another version, an audio tool such as a gate or trigger can be used to sense when the striking surface has been struck. This would work by sensing vibrations immediately after the drum has been struck. The electromechanical motor/actuator can be a servo motor, solenoid, electromagnet, stepper motor, or any other of many motion creating devices.

The percussion instrument dampening system 100 of the invention solves the problems associated with conventional percussion systems of undesired resonation in drums and other percussion instruments.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person of ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and to include zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A percussion instrument dampening system, the system comprising:
a percussion instrument having a striking surface that can be struck to generate a sound; and
a dampening system engageable with the percussion instrument, wherein the dampening system comprises:
a dampening member having a surface adapted to selectively contact the striking surface of the percussion instrument to reduce vibration of the striking surface;
a dampening member positioning mechanism adapted to move the dampening member between a dampening position and an undampening position;
a strike detecting system adapted to detect a strike of the striking surface; and
a controller adapted to receive a signal from the strike detecting system and to control the dampening member positioning mechanism in response to the signal,
wherein when a strike is detected by the strike detecting system, the controller causes the dampening member positioning mechanism to move the dampening member from the dampening position to the undampening position.

2. A system according to claim 1 wherein the controller causes the dampening member positioning mechanism to move from the undampening position to the dampening position when a period of time after the strike has lapsed.

3. A system according to claim 1 wherein the controller causes the dampening member positioning mechanism to move from the undampening position to the dampening position when a period of time after the strike has lapsed, and wherein the period of time is adjustable.

4. A system according to claim 1 wherein the controller causes the dampening member positioning mechanism to move to the dampening member from the undampening position to the dampening position when a period of time after the strike has lapsed, and wherein the speed of movement from the undampening position to the dampening position is adjustable.

5. A system according to claim 1 wherein the strike detecting system detects when the striking surface has been contacted.

6. A system according to claim 1 wherein the strike detecting system comprises a contact sensor associated with the striking surface.

7. A system according to claim 1 wherein the strike detecting system detects movement of a striking member towards the striking surface, wherein the strike is detected before contact is made.

8. A system according to claim 1 wherein the strike detecting system comprises a beam breaking sensor.

9. A system according to claim 1 wherein the dampening position is a position in which the dampening member contacts the striking surface, and the undampening position is a position in which the dampening member is spaced from the striking surface.

10. A system according to claim 1 wherein the dampening member contacts a bottom surface of the striking surface.

11. A system according to claim 1 wherein the dampening system comprises a plurality of dampening members.

12. A system according to claim 1 wherein the percussion instrument comprises a plurality of striking surfaces, and wherein the dampening system comprises a separate dampening member and strike detecting system for each striking surface.

13. A percussion instrument dampening system for use with a percussion instrument, the system comprising:
a dampening member having a surface adapted to selectively contact the striking surface of the percussion instrument to reduce vibration of the striking surface;
a dampening member positioning mechanism adapted to move the dampening member between a dampening position and an undampening position;
a strike detecting system adapted to detect a strike of the striking surface; and
a controller adapted to receive a signal from the strike detecting system and to control the dampening member positioning mechanism in response to the signal,
wherein when a strike is detected by the strike detecting system, the controller causes the dampening member positioning mechanism to move the dampening member from the dampening position to the undampening position.

14. A system according to claim 13 wherein the controller causes the dampening member positioning mechanism to move from the undampening position to the dampening position when a period of time after the strike has lapsed.

15. A system according to claim 13 wherein the controller causes the dampening member positioning mechanism to move from the undampening position to the dampening position when a period of time after the strike has lapsed, and wherein the period of time is adjustable.

16. A system according to claim 1 wherein the controller causes the dampening member positioning mechanism to move from the undampening position to the dampening position when a period of time after the strike has lapsed, and wherein the speed of movement from the undampening position to the dampening position is adjustable.

17. A system according to claim 1 wherein the strike detecting system detects when the striking surface has been contacted or when movement of a striking member towards the striking surface before contact is made.

18. A method of dampening a percussion instrument, the method comprising:
providing a percussion instrument having a striking surface that can be struck to generate a sound;
providing a dampening member in a dampening position where the dampening member contacts the striking surface to reduce vibration of the striking surface;
detecting a strike of the striking surface; and
in response to the detected strike, moving the dampening member to an undampening position.

19. A method according to claim 18 wherein the step of detecting a strike comprises detecting contact with the striking surface or detecting movement of an object towards the striking surface.

20. A method according to claim 18 wherein the dampening member is moved back to the dampening position after a period of time.
